(19) United States
(12) Patent Application Publication
(10) Pub. No.: US 2020/0261866 A1
(43) Pub. Date: Aug. 20, 2020

(54) FLOW STRAIGHTENER AND RELATED VENTURI MIXING DEVICE

(71) Applicant: SEKO S.P.A., Cittaducale (RI) (IT)

(72) Inventors: Gabriele PETRANGELI, Cittaducale (RI) (IT); Luigino ESPOSITO, Cittaducale (RI) (IT); Adrio PANTALEONI, Cittaducale (RI) (IT)

(21) Appl. No.: 16/754,653

(22) PCT Filed: Oct. 12, 2018
(86) PCT No.: PCT/IB2018/057947

§ 371 Date: Apr. 8, 2020

(30) Foreign Application Priority Data
Oct. 12, 2017 (IT) 102017000115299

(51) Int. Cl. B01F 5/04

(52) U.S. Cl. CPC B01F 5/0428; B01F 2215/0422; B01F 2215/0431; B01F 2005/0446

(57) ABSTRACT

Flow straightener (434; 43B) comprising a cylinder (44) having an inlet mouth (46) and an outlet mouth (47), the cylinder (44) being internally provided with a helical rib (45) running on an inner surface (450) of the cylinder (44), wherein a ridge (456; 460) of the helical rib (45) follows a cylindrical helix with pitch p wrapped around a cylindrical volume having diameter d coaxial with the cylinder (44), whereby the ridge (456; 460) of the helical rib (45) delimits a clear central cylindrical section of the cylinder (44) having diameter d, wherein the helical rib (45) has a front main surface (457), facing the inlet mouth (46), and a rear main surface (458), facing the outlet mouth (47), the front main surface (457) forming with the inner surface (450) of the cylinder (44) a front angle α that is obtuse, whereby 90°<α<180°.

The present invention refers to a flow straightener configured to create a swirling motion of the fluid flow ensuring a wide clear central section for the passage of the fluid.

The invention further refers to a venturi mixer device, in particular for a mixing apparatus, comprising such flow straightener, that is capable to activate in a reliable, efficient and inexpensive way in all operating conditions, ensuring a proper mixing and permitting to increase the flow rate of the mixing device, wherein the flow straightener allows to create a swirling motion of the fluid flow in the outlet channel of the venturi mixing device and permits the outlet channel to be filled, without generating either any resistance or any flow rate decrease.

In the following of the present description, reference will be mainly made to an application of the flow straightener according to the invention in the venturi mixing device according to the invention applied to a mixing apparatus. However, it should be noted that the flow straightener according to the invention may be applied to any apparatus, device, equipment, system wherein it is necessary to carry out a mixing of two or more liquids in a hydraulic circuit, still remaining within the scope of protection of the present invention.

It is known that mixing apparatuses are widespread. In particular, in the field of cleaning and disinfection of surfaces, such apparatuses allow both water-only treatment and addition of concentrated chemicals, such as for instance disinfectants, soaps, wet foams and dry foams. The apparatus disclosed in document U.S. Pat. No. 7,017,621 B2 and the apparatus called KP1H available from the US company Knight are two examples of such mixing apparatuses.

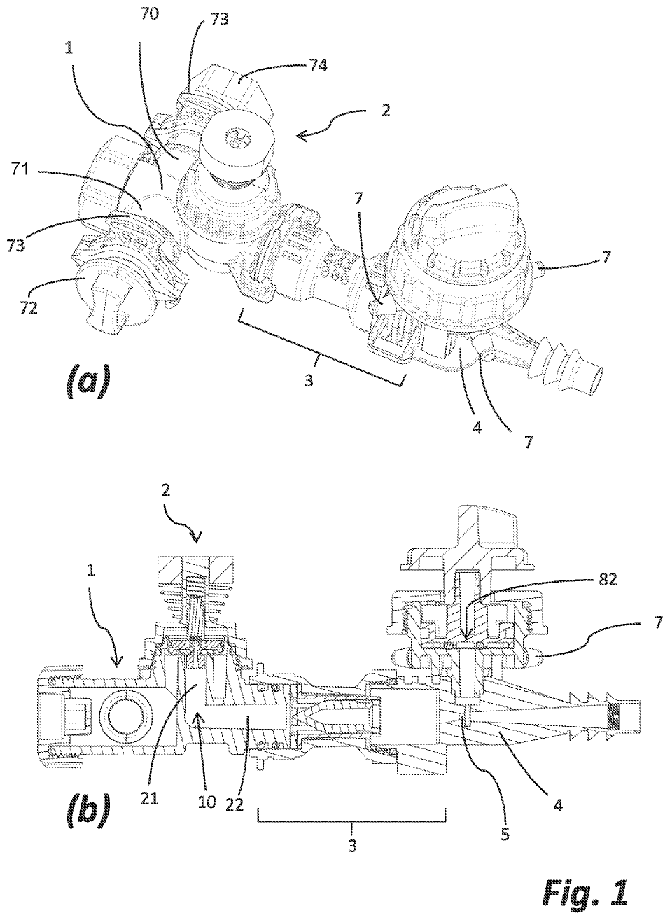

With reference to FIG. 1, it may be observed that the hydraulic circuit of such apparatuses draws the water from the supply through a hydraulic cross connection 1, capable to operate with water pressure values up to 10 bars (i.e. 10⁶ Pascals), controlled by a magnetically actuated valve 2; by way of example, and not by way of limitation, examples of such hydraulic cross connection and of such magnetically actuated valve are disclosed in documents WO 2013/011488 and WO 2013/011487. The hydraulic cross connection 1, the housing case (not shown in FIG. 1) of which is mounted on the wall (directly or through a bracket) so that the magnetically actuated valve 2 is frontally accessible by an operator, comprises an inlet duct 70 upstream of the valve 2, for connecting to the supply through a connector 74, and an outlet duct 71 allowing the connection to a hydraulic cross connection of another mixing apparatus (or to any other duct) connected downstream of that shown in FIG. 1 through a similar connector (not shown in FIG. 1). In the case where the outlet duct 71 is not connected to any downstream hydraulic cross connection (or any other duct), it is closed through a stopper 72. The connector 74 and the stopper 72 are attached to the inlet duct 70 and outlet duct 71, respectively, through corresponding quick coupling removable hooks 73 frontally applied (i.e. from the same side of the magnetically actuated valve 2) by an operator.

The hydraulic cross connection 1, downstream of the magnetically actuated valve 2, comprises an elbow 10 (formed by an upstream duct 21 and a downstream duct 22) downstream of which an assembly 3 of separation valves is present, for preventing the backflow of chemical products towards the supply, and, downstream of these, a mixing device 4 based on the Venturi effect, that mixes the water with the chemical product.

The presence of the assembly 3 of separation valves is necessary because the chemical product tanks are connected to the supply of drinking water, and backflow prevention of the chemical products towards the supply must be thus ensured, e.g. in the case where a temporary low pressure occurs in the supply.

In particular, the mixing device 4 comprises a main flow restricting channel 5 (i.e. configured to make a restriction of the main flow) wherein, upon the passage of water, a low pressure and hence an aspiration of the chemical product from a mouth 82 of an external tank and its dilution in water are generated. Dosage depends on the flow rate and water pressure, and it is possible to manage the dilution through proper nozzles 7 which are inserted into external tubes (not shown) for aspirating the chemical product, which adjust the percentage thereof.

Such apparatuses are completely automatic and, since they are constituted only by a hydraulic system, they do not need any power supply.

However, the prior art venturi mixing devices suffer from some drawbacks.

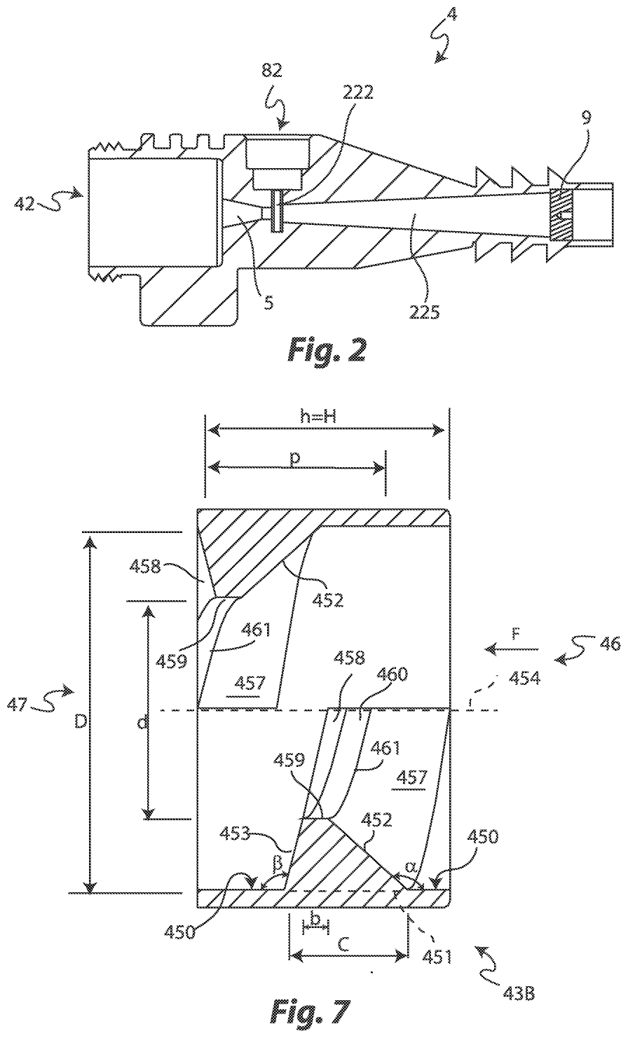

As schematically shown in FIG. 2, such drawbacks are mainly due to the fact that, firstly, immediately after the mixing device 4, i.e. after the outlet nozzle thereof, there is generally a free discharge, and that, secondly, the suction chamber 222 has an inlet section different from the outlet section.

This entails that air is present along the walls of the outlet channel 225 of the mixing device, i.e. in the channel downstream of the suction chamber 222, creating a difficulty in activating the mixing device, i.e. at the start of the aspiration of the chemical product from the mouth 82 of the external tank upon the passage of water, that only fills the central section of the outlet channel 225.

To solve such drawbacks, currently available venturi mixing devices are provided with one or more restrictions in the pipe connected to the outlet nozzle of the mixing device, in order to force the filling of the outlet channel 225 with the fluid, optionally water, permitting the aspiration from the mouth 82 of the external tank and, consequently, the activation of the mixing device. By way of example, such a restriction may consist of a constriction made by means of a ring external to the pipe.

However, even this solution entails drawbacks, since it involves the use of a special pipe for operating of the mixing device.

Also, the performance of the mixing device is reduced, since the restrictions generate a resistance at the outlet of the channel 225 that subtracts suction power from the device and reduces its flow rate.

To solve these problems, some prior art mixing devices are provided with flow straighteners (shown in FIGS. 1b and 2 where it is indicated by the reference numeral 9) which break the mixed fluid flow coming from the suction chamber, as for instance disclosed in documents U.S. Pat. No. 4,014,961, US 2009/0314702 and IT RM2011000386. However, even such prior art mixing devices suffer from some drawbacks, due to the necessary restriction of the free opening offered to the flow which entails a pressure drop (i.e. a fluid pressure drop) in steady state operating conditions and a high probability of creating obstructions in the mixing device channels due to limestone or chemical reactions. Also, spiral mixing devices and flow guide helical elements for catalytic converters are disclosed in CA 2364735 and DE 19839754, respectively.

A further solution of the prior art, limited to some specific applications, is disclosed in document US 2005/0173336. However, this solution makes the mixing device rather complex and expensive.

It is an object of this invention, therefore, to allow in a reliable, efficient and inexpensive way, to activate a venturi mixing device in all operating conditions, ensuring a proper mixing and permitting to increase the flow rate of the mixing device.

It is specific subject-matter of the present invention a flow straightener comprising a cylinder configured to be stably placed in un duct and having an inlet mouth and an outlet mouth, the cylinder being internally provided with one helical rib running on an inner surface of the cylinder, wherein a ridge of the helical rib follows a cylindrical helix with pitch p wrapped around a cylindrical volume having diameter d coaxial with the cylinder, whereby the ridge of the helical rib delimits a clear central cylindrical section of the cylinder having diameter d, wherein the helical rib has a front main surface, facing the inlet mouth, and a rear main surface, facing the outlet mouth, the front main surface forming with the inner surface of the cylinder a front angle α that is obtuse, whereby

90°<α<180°.

According to another aspect of the invention, the inner surface del cylinder may have diameter D and wherein the diameter d of the clear central cylindrical section may range from 40% to 90% of D, i.e.

0.4·D≤d≤0.9·D,

optionally may range from 50% to 75% of D, i.e.

0.5·D≤d≤0.75·D,

more optionally may range from 60% to 65% of D, i.e.

0.6·D≤d≤0.65·D.

According to a further aspect of the invention, the front angle α may range from 115° to 165°, optionally from 120° to 150°, more optionally from 130° to 140°.

According to an additional aspect of the invention, the rear main surface may form with the inner surface of the cylinder a rear angle β ranging from 45° to 135°, optionally from 75° to 120°, more optionally from 90° to 105°, still more optionally the rear angle β being substantially equal to 90°.

According to another aspect of the invention, a ratio between pitch p of the cylindrical helix followed by the ridge of the helical rib and length c of a projection of the helical rib on the inner surface of the cylinder may be not lower than 1, i.e.

p≥c.

According to a further aspect of the invention, the cylinder may have height H and the helical rib may extend only for the whole height H of the cylinder.

According to an additional aspect of the invention, the ridge of the helical rib may describe not more than two turns of the cylindrical helix, optionally at least one-half of a turn of the cylindrical helix, more optionally only one turn of the cylindrical helix.

According to another aspect of the invention, the ridge of the helical rib may be substantially linear.

According to a further aspect of the invention, the ridge of the helical rib may be a surface that is a helical portion of a cylindrical surface.

According to an additional aspect of the invention, the helical rib may have polygonal axial cross-section.

According to another aspect of the invention, the helical rib may have triangular axial cross-section, optionally with right angle triangle shape.

According to a further aspect of the invention, the helical rib may have trapezoidal axial cross-section.

It is specific subject-matter of the present invention a venturi mixer device comprising a body having an inlet and an outlet nozzle, and, internally to the body, a main flow restricting channel communicating with the inlet and with a suction chamber, the suction chamber being in communication with a mouth communicating with the outside, an outlet channel being in communication with the suction chamber and ending the outlet nozzle, wherein the outlet channel is provided with the just described flow straightener, wherein the inlet mouth of the cylinder del flow straightener is facing the inlet of the venturi mixer device and the outlet mouth of the cylinder of the flow straightener is facing the outlet nozzle of the venturi mixer device.

According to an additional aspect of the invention, the flow straightener may be placed in correspondence with the outlet nozzle.

In general, the flow-straightener according to the invention comprises a cylinder configured to be placed in a duct (stably, for instance by means of an snap-fit coupling with the duct, or by gluing); in particular, the flow straightener according to the invention is configured to be applied in a venturi mixing device and to create a swirling motion of the fluid flow in the outlet channel of the venturi mixing device and to permit the outlet channel to be filled, ensuring a wide clear central section for the passage of the fluid. In other words, the flow straightener according to the invention effectively allows the activation of the venturi mixing device and the outlet channel thereof to be filled, without generating any resistance or flow rate decrease, substantially obtaining no pressure drop in steady state operating conditions with respect to the prior art solutions.

Moreover, the flow straightener according to the invention drastically reduces the necessary restriction surface of the outlet channel of the venturi mixing device and guarantees a wide passage free from elements, avoiding possible obstructions due to limestone or chemical reactions.

The present invention will be now described, by way of illustration and not by way of limitation, according to its preferred embodiments, by particularly referring to the Figures of the annexed drawings, in which:

FIG. 1 schematically shows a perspective view (FIG. 1a) and a longitudinal section view (FIG. 1b) of the hydraulic circuit of a mixing apparatus according to the prior art;

FIG. 2 schematically shows a longitudinal section view of a venturi mixer device according to the prior art;

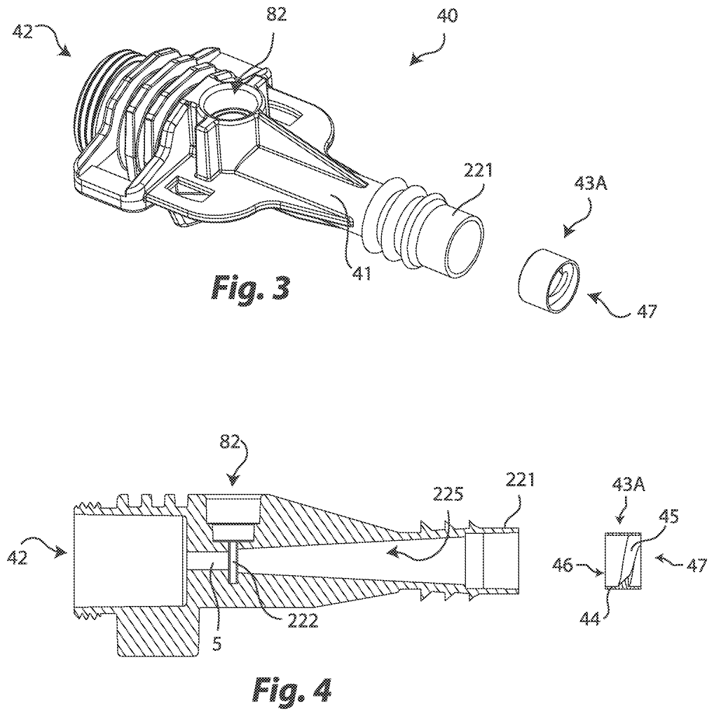

FIG. 3 shows an exploded perspective view of a preferred embodiment of the venturi mixer device according to the invention;

FIG. 4 shows an exploded longitudinal section view of the mixing device of FIG. 3;

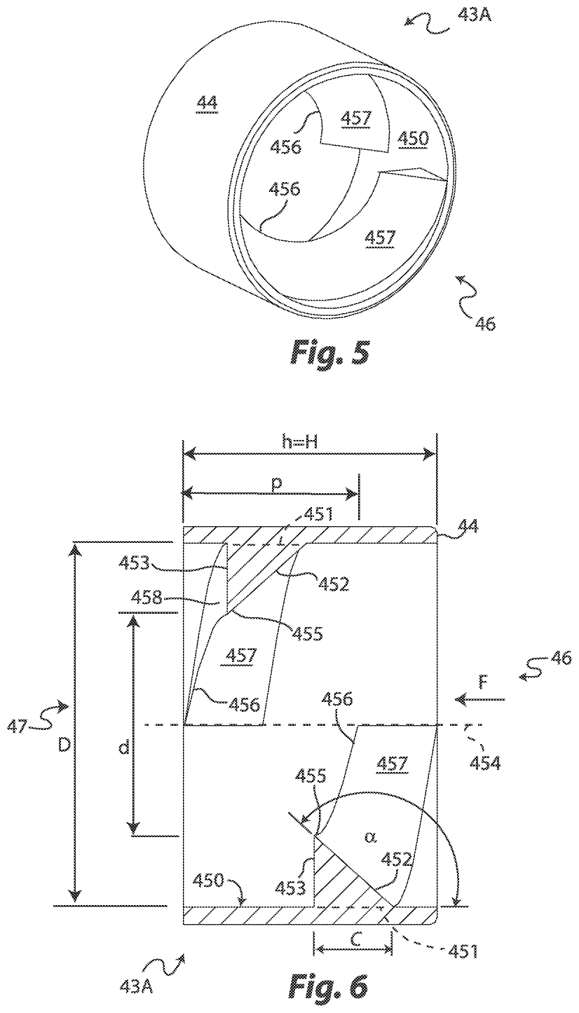

FIG. 5 shows a perspective view of a first embodiment of the flow straightener according to the invention;

FIG. 6 shows an axial plane section view of the flow straightener of FIG. 5; and

FIG. 7 shows an axial plane section view of a second embodiment of the flow straightener according to the invention.

In the Figures identical reference numerals will be used for alike elements.

Making reference to FIGS. 3 and 4, a preferred embodiment of the venturi mixing device 40 according to the invention comprises a body 41 having an inlet 42 and un outlet nozzle 221. Internally to the body 41, the mixing device 40 comprises a main flow restricting channel 5 (i.e. configured to make a restriction of the main flow) wherein, upon the passage of water coming from the inlet 42, a low pressure and hence an aspiration of the chemical product from a mouth 82 of an external tank and its dilution in water are generated, which dilution occurs in the outlet channel 225, starting from the suction chamber 222 and ending with the outlet nozzle 221.

In correspondence with the outlet nozzle 221, the outlet channel 225 is provided with a first embodiment of the flow straightener 43A according to the invention, comprising or consisting of a cylinder 44 having an inlet mouth 46, where the fluid flow enters, and an outlet mouth 47, from which the fluid flow exits; in particular, when the flow straightener 43A is inserted into the outlet nozzle 221 of the outlet channel 225 of the mixing device 40, the inlet mouth 46 is facing the inlet 42 of the mixing device 40 itself, while the outlet mouth 47 is facing (optionally aligned with) the outlet nozzle 221. In other words, the cylinder 44 is configured to be stably placed in a duct, i.e. in the outlet channel 225.

Making reference also to FIGS. 5 and 6, it may be observed that the cylinder 44, having height H, is internally provided with one helical rib 45 with triangular axial cross-section running on the inner surface 450 of the cylinder 44 from the inlet mouth 46 to the outlet mouth 47. The triangular axial cross-section of the helical rib 45 has a base side 451, having length c, lying on the inner surface 450 of the cylinder 44, a front side 452 facing the inlet mouth 46, and a rear side 453 facing the outlet mouth 47. As shown in FIGS. 5-6, the front side 452 corresponds to the front surface 457 of the helical rib 45 directly exposed and opposed to the direction of the fluid flow (represented by arrows F in FIG. 6), the base side 451 corresponds to the projection of the front surface 457 of the helical rib 45 on the inner surface 450 of the cylinder 44, and the rear side 453 corresponds to the rear surface 458 of the helical rib 45 not opposed to the direction F of the fluid flow; in particular, the front surface 457 remains directly exposed and opposed to the direction F of the fluid flow for the whole extension, i.e. for the whole height h, of the helical rib 45, whereby the rear surface 458 remains not opposed to the direction F of the fluid flow for the whole height h of the helical rib 45. The front side 452 corresponds to the width of the front surface 457 (and optionally remains constant for the whole height h of the helical rib 45); similarly, the rear side 453 corresponds to the width of the rear surface 458 (and optionally remains constant for the whole height h of the helical rib 45). In the first embodiment of the flow straightener shown in FIGS. 3-6, the triangular axial cross-section of the helical rib 45 is a rectangle triangle wherein the rear side 453 is orthogonal to the inner surface 450 of the cylinder 44 and the front side 452 is the rectangle triangle hypotenuse (whereby the base side 451 corresponds to the projection of the helical rib 45 on the inner surface 450 of the cylinder 44); however, it must be noted that in other embodiments of the flow straightener according to the invention, the helical rib may have an axial cross-section shaped as any triangle, in particular not a rectangle triangle.

The inner surface 450 of the cylinder 44, the axis of which is indicated with reference numeral 454, has diameter D. The ridge 456 (that is substantially linear) of the helical rib 45, defined by the vertex 455 of the triangular axial cross-section of the helical rib 45 inside the cylinder 44 (i.e. the triangular axial cross-section vertex 455 opposed to the inner surface 450 of the cylinder 44 and to the base side 451 of the triangular axial cross-section of the helical rib 45) delimits a clear central cylindrical section having diameter d of the flow straightener 43A. In other words, the ridge 456 of the helical rib 45 follows a cylindrical helix wrapped around a cylindrical volume having diameter d coaxial with the cylinder 44; in particular, in the flow straightener 43A of FIGS. 3-6, such cylindrical helix is right handed (i.e. the helix axial advancement occurs with a right handed rotation, i.e. clockwise), even if this is not an essential feature for the invention.

In the first embodiment of the flow straightener shown in FIGS. 3-6:
the front angle α formed, externally to the axial cross-section triangle, by the front side 452 and by the inner surface 450 of the cylinder 44 (i.e. the front angle formed by the front surface 457 of the helical rib 45 and by the inner surface 450 of the cylinder 44), that is preferably substantially constant, is substantially equal to 135° (whereby the triangular axial cross-section of the helical rib 45 is a isosceles rectangle triangle);
the cylindrical helix pitch p (i.e. the height of one full turn of the helix measured parallel to the helix axis 454) is substantially equal to 220% of the length c of the base side 451 of the triangular axial cross-section of the helical rib 45, i.e.

p=2.2·c;
the diameter d of the clear central cylindrical section of the flow straightener 43A defined (by the vertex 455 of the triangular axial cross-section of the helical rib 45 inside the cylinder 44, i.e.) by the ridge 456 of the helical rib 45 is substantially equal to 62% of the diameter D of the inner surface 450 of the cylinder 44;
the helical rib 45 extends for the whole height H del cylinder 44 (i.e. the height h of the helical rib 45 is equal to the height H of the cylinder 44, i.e. h=H); and
the ridge 456 describes one full turn of the cylindrical helix wrapped around the cylindrical volume of diameter d, whereby the front surface 457 describes one full turn of the cylindrical helix.

Other embodiments of the flow straightener according to the invention may have the helical rib having a polygonal axial cross-section wherein the polygon has more than three sides, instead of a triangular axial cross-section. By way of example, and not by way of limitation, FIG. 7 shows a second embodiment of the flow straightener according to the invention, indicated with reference numeral 43B, having one helical rib having a trapezoidal axial cross-section running on the inner surface 450 of the cylinder 44 from the inlet mouth 46 to the outlet mouth 47 for the whole height h of the cylinder 44 (i.e. the height h of the helical rib is equal to the height H of the cylinder 44, i.e. h=H); in particular, the trapezium of the axial cross-section is not rectangular, even if in other embodiments of the flow straightener according to the invention the helical rib may have a rectangular trapezium shaped axial cross-section. The trapezoidal axial cross-section of the helical rib has also a base side 451, having length c, lying on the inner surface 450 of the cylinder 44, a front side 452 facing the inlet mouth 46, a rear side 453 facing the outlet mouth 47, and an inner side 459 parallel to the inner surface 450 of the cylinder 44 (i.e. parallel to the base side 451), having length b shorter than c (i.e. b<c). The front side 452 corresponds to the front surface 457 of the helical rib directly exposed and opposed to the fluid flow direction F, the base side 451 corresponds to the projection of the helical rib on the inner surface 450 del cylinder 44, the rear side 453 corresponds to the rear surface 458 of the helical rib not opposed to the fluid flow direction F, and the inner side 459 corresponds to the surface 460 constituting the helical rib ridge and that is a helical portion of a cylindrical surface of diameter d coaxial to the cylinder 44 (i.e. it is a portion delimited by a front edge 461 and a rear edge 462 parallel to each other each of which follows a cylindrical helix wrapped around a cylindrical volume having diameter d coaxial with the cylinder 44). In other words, the surface 460 constituting the helical rib ridge follows a cylindrical helix wrapped around a cylindrical volume having diameter d coaxial with the cylinder 44; even in the flow straightener 43B of FIG. 7, such cylindrical helix is right handed (even if, as stated above, this is not an essential feature for the invention).

In the second embodiment of the flow straightener shown in FIG. 7:
the front angle α formed, externally to the axial cross section trapezium, by the front side 452 and by the inner surface 450 of the cylinder 44 (i.e. the front angle formed by the front surface 457 of the helical rib and by the inner surface 450 of the cylinder 44) is still substantially equal to 135°;
the rear angle β formed, externally to the axial cross section trapezium, by the rear side 453 and by the inner surface 450 of the cylinder 44 (i.e. the rear angle formed by the rear surface 458 of the helical rib and by the inner surface 450 of the cylinder 44), that is preferably substantially constant, is substantially equal to 105°;
the cylindrical helix pitch p is substantially equal to 4/3 of the length c of the base side 451 of the trapezoidal axial cross-section of the helical rib, i.e.

p=(4/3)·c;
the length b is 20% of the length c;
the diameter d of the clear central cylindrical section of the flow straightener 43B defined by the surface 460 constituting the helical rib ridge is still substantially equal to 62% of the diameter D of the inner surface 450 of the cylinder 44;
the helical rib still extends for the whole height H of the cylinder 44, i.e. the height h of the helical rib is equal to the height H of the cylinder 44, i.e. h=H; and
the front edge 461 of the surface 460 constituting the helical rib ridge describes one full turn of the cylindrical helix wrapped around the cylindrical volume of diameter d, whereby the front surface 457 describes one full turn of the cylindrical helix.

In further embodiments of the flow straightener according to the invention, the helical rib may have a polygonal axial cross-section different from a triangular or trapezoidal axial cross-section as those shown for the straightener 43A (see FIGS. 3-6) and for the straightener 43B (see FIG. 7), respectively. Moreover, the helical rib may have an axial cross section different from a polygonal cross section, for instance comprising at least partially one or more curvilinear contours.

Generally, the flow straightener according to the invention has the helical rib having (at least) one front main surface, i.e. a surface facing the inlet mouth of the flow straightener that is directly exposed and opposed to the fluid flow direction F for the whole height h of the helical rib 45 and that has a width optionally remaining constant for the whole height h of the helical rib 45, and (at least) one rear main surface, i.e. a surface facing the outlet mouth of the flow straightener that is not opposed to the fluid flow direction F for the whole height h of the helical rib 45 and that has a width optionally remaining constant for the whole height h of the helical rib 45, wherein the front main surface forms with the inner surface 450 of the cylinder 44 (at least) one respective front angle α that is preferably substantially constant and that is obtuse, whereby

90°<α<180°,

and the rear main surface forms with the inner surface 450 of the cylinder 44 (at least) one respective rear angle β that is preferably substantially constant. Optionally, the front angle α ranges from 115° to 165° (i.e. 115°≤α≤165°), more optionally ranging from 120° to 150° (i.e. 120°≤α≤150°), still more optionally ranging from 130° to 140° (i.e. 130°≤α≤140°). The rear angle β optionally ranges from 45° to 135° (i.e. 45°≤β≤135°), whereby the rear main surface forms with the inner surface 450 of the cylinder 44 a sort of recess (creating a low pressure in the fluid) when the rear angle β is acute (i.e. when β<90°); more optionally the rear angle β ranges from 75° to 120° (i.e. 60°≤β≤120°), still more optionally the rear angle β ranges from 90° to 105° (i.e. 90°≤β≤105°), even more optionally the rear angle β is substantially equal to 90°. Obviously, the just indicated values for the front and rear angles α and β may be used for embodiments of the flow straightener according to the invention having helical rib with triangular or trapezoidal axial cross-section similar to those shown in FIGS. 6 and 7, respectively (it must be noted that the rear angle (3 of the flow straightener 43A of FIG. 6 is substantially equal to 90°).

In further embodiments of the flow straightener according to the invention, the values of the ratio between the diameter d of the clear central cylindrical section of the flow straightener defined by the helical rib ridge and the diameter D of the inner surface 450 of the cylinder 44 may be different from that of the embodiments shown in FIGS. 6 and 7 (equal to 0, 62). In general, the diameter d of the clear central cylindrical section optionally ranges from 40% to 90% of D, i.e.

0.4·D≤d≤0.9·D,

more optionally ranges from 50% to 75% of D, i.e.

0.5·D≤d≤0.75·D,

still more optionally ranges from 60% to 65% of D, i.e.

0.6·D≤d≤0.65·D.

In other embodiments of the flow straightener according to the invention, the values of the ratio between cylindrical helix pitch p and length c of the base side 451 of the helical rib axial cross section may be different from those of the embodiments shown in FIGS. 6 and 7, substantially equal to 2, 2 and 4/3, respectively). In particular, the ratio between cylindrical helix pitch p and length c of the base side 451 of the helical rib axial cross section must be configured to create a swirling motion of the fluid entering the inlet mouth 46; generally, the optimal value may also depend on the fluid flow speed, fluid viscosity and ratio between diameter d of the clear central cylindrical section and diameter D of the inner surface 450 of the cylinder 44. Optionally, the ratio between cylindrical helix pitch p and length c of the base side 451 of the helical rib axial cross section is not lower than 1, i.e.

p≥c

Other embodiments of the flow straightener according to the invention may have the helical rib extending only for a portion, optionally a central one, of the height H of the cylinder 44, whereby the helical rib height h is generally less or equal to the height H of the cylinder 44, i.e. h≤H.

Further embodiments of the flow straightener according to the invention may have the helical rib ridge that describes more than one full turn, not necessarily an integer number of turns, preferably not more than two full turns (in order not to introduce significant pressure drops, most of all in in steady state operating conditions), or less than one full turn of the cylindrical helix wrapped around the cylindrical volume of diameter d. Optionally, the helical rib ridge describes at least half of a full turn of the cylindrical helix wrapped around the cylindrical volume of diameter d, whereby the helical rib ridge may describe a helix with height h equal to k·p (i.e. h=k·p), where k is a positive value, even a decimal one, preferably not larger than 2 (i.e. k≤2), optionally not lower than 0, 5 (i.e. k≥0, 5).

In further embodiments of the flow straightener according to the invention, the helical rib ridge may follow a left handed cylindrical helix (i.e. the helix axial advancement occurs with a left handed rotation, i.e. counterclockwise).

Thanks to its structure, the flow straightener according to the invention effectively acts for breaking the fluid flow creating a swirling motion of the mixed fluid in the outlet channel 225 of the venturi mixing device 40. This allows the outlet channel 225 itself to be filled, ensuring a wide clear central section, having diameter d, for the passage of the fluid and, consequently, it effectively allows the venturi mixing device to activate, without generating any resistance or flow rate decrease, substantially obtaining no pressure drop in steady state operating conditions and avoiding possible obstructions due to limestone or chemical reactions.

Differently from the preferred embodiment shown in FIGS. 3-4, other embodiments of the venturi mixer device according to the invention may have the outlet channel that is provided with a flow straightener according to the invention not necessarily placed in correspondence with the outlet nozzle.

The preferred embodiments of this invention have been described and a number of variations have been suggested hereinbefore, but it should be understood that those skilled in the art can make other variations and changes without so departing from the scope of protection thereof, as defined by the attached claims.

1-14. (canceled)

15. Venturi mixing device comprising a body having an inlet and an outlet nozzle, and, internally to the body, a main flow restricting channel communicating with the inlet and with a suction chamber, the suction chamber being in communication with a mouth communicating with the outside, an outlet channel being in communication with the suction chamber and ending with the outlet nozzle, wherein the outlet channel is provided with a flow straightener comprising a cylinder configured to be stably placed in a duct and having an inlet mouth and an outlet mouth, the cylinder being internally provided with a helical rib running on an inner surface of the cylinder, wherein a ridge of the helical rib follows a cylindrical helix with height h and with pitch p wrapped around a cylindrical volume having diameter d coaxial with the cylinder, whereby the ridge of the helical rib delimits a clear central cylindrical section of the cylinder having diameter d, wherein the helical rib has a front main surface, facing the inlet mouth for the whole height h of the helical rib, and a rear main surface, facing the outlet mouth for the whole height h of the helical rib, the front main surface forming with the inner surface of the cylinder a front angle α that is obtuse, whereby
90°<a<180°,
wherein the inlet mouth of the cylinder of the flow straightener is facing the inlet of the venturi mixing device and the outlet mouth of the cylinder of the flow straightener is facing the outlet nozzle of the venturi mixing device.

16. Venturi mixing device according to claim 15, wherein the inner surface of the cylinder has diameter D and wherein the diameter d of the clear central cylindrical section ranges from 40% to 90% of D, i.e.
0.4·D≤d≤0.9·D.

17. Venturi mixing device according to claim 15, wherein the front angle α ranges from 115° to 165°.

18. Venturi mixing device according to claim 15, wherein the rear main surface forms with the inner surface of the cylinder a rear angle b ranging from 45° to 135°.

19. Venturi mixing device according to claim 15, wherein a ratio between pitch p of the cylindrical helix followed by the ridge of the helical rib and length c of a projection of the helical rib on the inner surface of the cylinder is not lower than 1, i.e.
p≥c.

20. Venturi mixing device according to claim 15, wherein the cylinder has height H and the helical rib extends only for the entire height H of the cylinder.

21. Venturi mixing device according to claim 15, wherein the ridge of the helical rib describes not more than two turns of the cylindrical helix.

22. Venturi mixing device according to claim 15, wherein the ridge of the helical rib is substantially linear.

23. Venturi mixing device according to claim 15, wherein the ridge of the helical rib is a surface that is a helical portion of a cylindrical surface.

24. Venturi mixing device according to claim 22, wherein the helical rib has polygonal axial cross-section.

25. Venturi mixing device according to claim 22, wherein the helical rib has triangular axial cross-section.

26. Venturi mixing device according to claim 23, wherein the helical rib has trapezoidal axial cross-section.

27. Venturi mixing device according to claim 15, wherein the flow straightener is placed in correspondence with the outlet nozzle.

28. Venturi mixing device according to claim 16, wherein the diameter d of the clear central cylindrical section ranges from 50% to 75% of D, i.e.
0.5··D≤d≤0.75·D.

29. Venturi mixing device according to claim 28, wherein the diameter d of the clear central cylindrical section ranges from 60% to 65% of D, i.e.
0.6·D≤d≤0.65·D.

30. Venturi mixing device according to claim 17, wherein the front angle α ranges from 120° to 150°.

31. Venturi mixing device according to claim 30, wherein the front angle α ranges from 130° to 140°.

32. Venturi mixing device according to claim 18, wherein the rear angle b ranges from 75° to 120°.

33. Venturi mixing device according to claim 32, wherein the rear angle b ranges from 90° to 105°.

34. Venturi mixing device according to claim 33, wherein the rear angle b is substantially equal to 90°.

35. Venturi mixing device according to claim 15, wherein the ridge of the helical rib describes at least one-half of a turn of the cylindrical helix.

36. Venturi mixing device according to claim 35, wherein the ridge of the helical rib describes only one turn of the cylindrical helix.

37. Venturi mixing device according to claim 25, wherein the helical rib has right angle triangle shape.
